(19) United States
(12) Patent Application Publication
(10) Pub. No.: US 2015/0305544 A1
(43) Pub. Date: Oct. 29, 2015

(54) MULTI-STYLE BREWER

(71) Applicant: Kone Technologies Inc., Hampstead, NH (US)

(72) Inventor: Michael Lancey, Windham, NH (US)

(73) Assignee: KONE TECHNOLOGIES INC., Hampstead, NH (US)

(21) Appl. No.: 14/263,481

(22) Filed: Apr. 28, 2014

(51) Int. Cl. A47J 31/06; A23F 5/26; A23F 3/18

(52) U.S. Cl. CPC A47J 31/0621; A23F 3/18; A23F 5/262

(57) ABSTRACT

A multi-style brewing device can be configured to brew French press, automatic drip and pour-over style coffee. An adjustable inflow control valve regulates the rate at which water enters the brew vessel. An adjustable outflow control valve regulates the rate at which liquid exits the brew vessel. The control valves can be used to control both the contact time between the water and the grounds, and the average volumetric ratio of water to grounds during contact, thereby reproducing various different brewing styles.

### BACKGROUND

The subject matter of this disclosure is generally related to beverages which are prepared by introducing a liquid such as water to a flavoring material such as ground coffee beans or tea leaves. A variety of different brewing styles are known. In general, the taste of the brewed beverage is a function of variables which may include ground size, volume of grounds, water volume, water temperature, water pressure, contact time between the liquid and the grounds, and the average volumetric ratio of water to grounds during contact. Different brewing styles are characterized by differences in these variables, resulting in different flavors being extracted from the grounds.

Tea is typically prepared by steeping a tea-filled filter bag in a vessel containing heated water. The filter bag is removed when the desired flavor has been attained. Steeping times vary according to the preferences of the consumer. Depending on the type of tea and other factors the tea leaves may steep for 1-6 minutes.

One style of coffee brewing is “French press.” A French press coffee maker includes a beaker, a lid, and a filter with a backing plate and plunger. The filter and backing plate are attached to the plunger, which passes through a hole in the lid. A coarse grind coffee is typically used, e.g., average particle size of about 0.6 mm to 1 mm. The ground coffee is placed in the beaker and all of the heated water to be used in the finished beverage is poured into the beaker. After a contact time of about four minutes the plunger is used to apply force to the filter, thereby moving most of the coffee grounds toward the bottom of the beaker. The resulting beverage may then be poured. Although it is a manually operated device, the French press does not require much skill or knowledge to operate and produces relatively uniform results with proper attention to using the proper ground size and contact time. However, the cleanup can be messy and fine particles tend to pass through the filter and settle at the bottom of the cup after the coffee is poured.

Another style of coffee preparation is “automatic drip.” Residential and commercial automatic drip coffee makers are widely used in North America. A typical automatic drip coffee maker includes a water reservoir, a heating element, a water pump, a filter basket, and a carafe. A medium grind coffee is typically used, e.g., average particle size of about 0.4 mm. The ground coffee is placed in a filter which is inserted into the filter basket. The filter basket is positioned above the carafe. Heated water from the reservoir is then introduced to the filter basket via the water pump. The filter basket has an opening via which liquid can exit. Consequently, the heated water passes through the coffee grounds and into the carafe via the force of gravity. The heated water may be introduced to the filter basket in a steady stream or in multiple pulses. The flow rate of the liquid exiting the filter basket may be less than the flow rate of the liquid entering the filter basket during inflow pulses. Consequently, liquid tends to pool in the filter basket while the grounds are in contact with the liquid. Automatic drip coffee makers are popular because they do not require skill or knowledge to operate, and produce relatively uniform results without messy cleanup. However, they are not generally viewed as producing a high quality beverage.

Another style of coffee preparation may be generally referred to as “pour-over.” Pour-over is a craft brewing technique that includes variations such as “Chemex,” “Melitta,” and “Hario.” A medium-fine grind coffee may be used, e.g., average particle size of about 0.3 mm. The ground coffee is placed in a filter which is placed in a special cone. The cone is placed over a carafe, cup, beaker or other receptacle. Heated water is then manually poured over the grounds. The cone includes an outlet opening via which liquid can exit. Consequently, the heated water passes through the coffee grounds and into the receptacle via the force of gravity. The ratio of water to grounds during extraction is managed by manually adjusting pouring rate or even stopping and restarting pouring, depending on desired results. Contact time is a function of the rate at which the water is manually introduced, and also filter type, grind size, cone shape, cone outlet size and other cone features such as ribs which provide channels between the cone and the filter. Consequently, the quality and flavor of the beverage depends on the skill and knowledge of the person preparing the beverage in addition to the type of cone and filter being utilized. However, if properly implemented this style is generally viewed as producing a high quality beverage.

Some other more specialized methods use even finer grind sizes. For example, espresso uses a fine grind of about 0.2 mm average particle size and forces the heated water through the grounds under high pressure with an espresso coffee maker. Turkish coffee uses grounds that are even finer than the espresso grind, e.g., a flour-like grind.

### SUMMARY

All examples and features mentioned below can be combined in any technically possible way.

In accordance with an aspect, an apparatus comprises: a brewing vessel; and an adjustable outflow valve connected to the brewing vessel. Implementations may include one of the following features, or any combination thereof. In some implementations the outflow valve controls contact time between water and grounds in the brewing vessel. In some implementations a water reservoir and an adjustable inflow valve are connected to the brewing vessel, and the inflow valve controls a rate at which water flows into the brewing vessel. In some implementations the inflow valve and outflow valve are set to achieve a predetermined contact time between water and grounds in the brewing vessel. In some implementations the inflow valve and outflow valve are set to achieve a predetermined average volumetric ratio of water to grounds in the brewing vessel during contact. In some implementations a diffuser is connected to the inflow valve to distribute water flowing into the brewing vessel in a predetermined pattern. In some implementations an inflow valve setting indicator and an outflow valve setting indicator are provided for an automatic drip style. In some implementations an inflow valve setting indicator is provided for a pour-over style.

In accordance with another aspect a method comprises: placing a predetermined amount of grounds in a brewing vessel; setting an adjustable outflow valve connected to the brewing vessel to a setting selected plurality of settings corresponding to different brew styles; and causing water to flow into the brewing vessel. Implementations may include one of the following features, or any combination thereof. In some implementations the method comprises changing the setting of the outflow valve to control contact time between the water and the grounds in the brewing vessel. In some implementations the method comprises setting an adjustable inflow valve connected to the brewing vessel to a setting selected plurality of settings corresponding to the brew styles, and in which the inflow valve controls a rate at which the water flows into the brewing vessel. In some implementations the method comprises changing the settings of the inflow valve and outflow valve to achieve a different brew style corresponding to a different contact time between water and grounds in the brewing vessel. In some implementations the method comprises changing the settings of the inflow valve and outflow valve to achieve a different brew style corresponding to a different average volumetric ratio of water to grounds in the brewing vessel during contact.

### BRIEF DESCRIPTION OF THE FIGURES

FIG. 1 is a perspective view of a multi-style brewing device.

FIG. 2 is a front elevation of the brewing device of FIG. 1.

FIG. 3 is an exploded view of the device of FIG. 1.

FIG. 4 illustrates use of the device of FIG. 1 to produce French press style coffee.

FIG. 5 illustrates use of the device of FIG. 1 to produce automatic drip style coffee.

FIG. 6 illustrates use of the device of FIG. 1 to produce pour-over style coffee.

FIG. 7 is a flow diagram of a method of changing brew style using the multi-style brewing device of FIG. 1.

### DETAILED DESCRIPTION

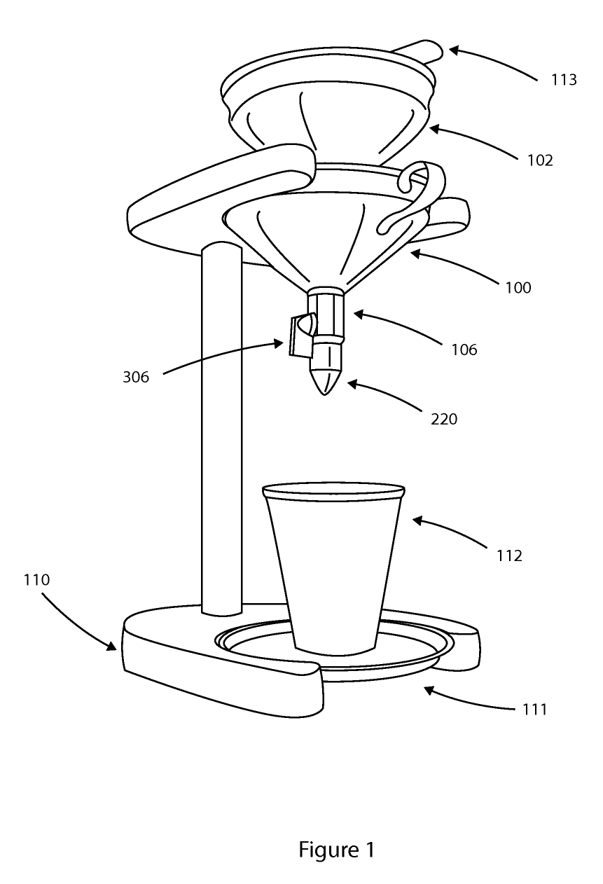

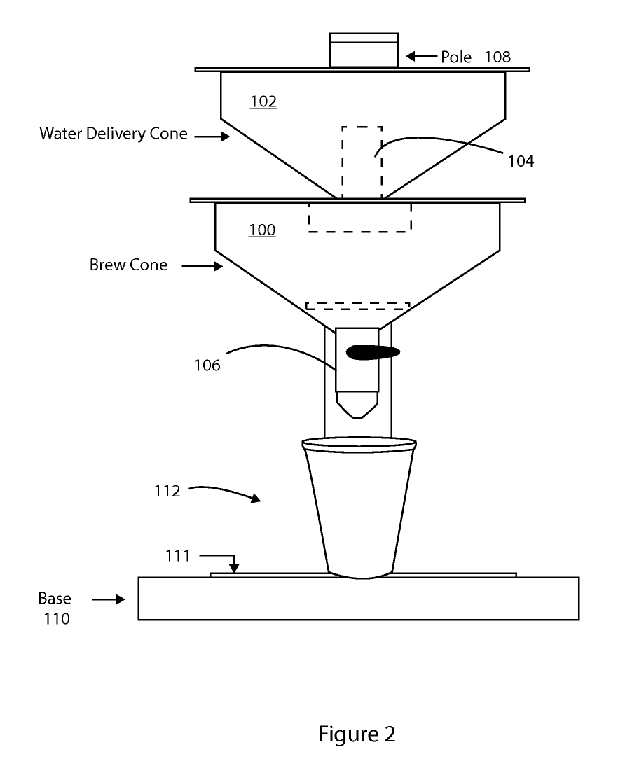

Referring to FIGS. 1 and 2, a multi-style brewing device can be configured to brew French press, automatic drip and pour-over style coffee, as well as tea and a wide variety of other beverages and styles. In the illustrated example the device includes a brew vessel 100 and a water reservoir 102. An adjustable inflow control valve 104 regulates the rate at which liquid from the water reservoir 102 enters the brew vessel 100. An adjustable outflow control valve 106 regulates the rate at which liquid exits the brew vessel 100. One or both of the control valves can be used to configure and control the brewing device to reproduce different brewing styles in accordance with the selection of the operator. More particularly, the valves can be used to control both the contact time between the water and the grounds in the brew vessel, and the average volumetric ratio of water to grounds during contact in the brew vessel. Adjusting the device to provide different brew styles is described below following a description of elements of the device.

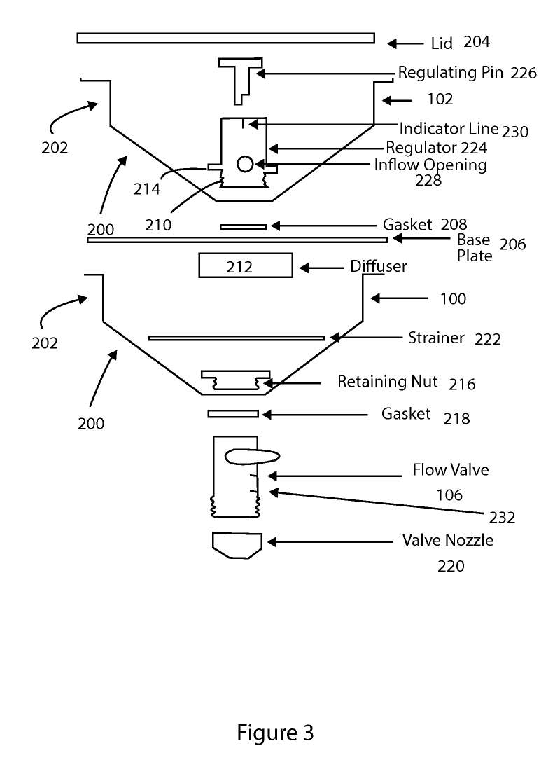

Referring to FIGS. 1 through 3, the water reservoir 102 and brew vessel 100 may each include a lower truncated conical section 200 and an upper cylindrical section 202. The material of which the water reservoir and brew vessel are constructed may be selected for its thermal properties, e.g., a material which is a poor thermal conductor and has relatively little thermal mass. A lid 204 which covers the top of the reservoir and a base plate 206 which covers the top of the brew vessel may be constructed of similar material. It will be appreciated however that a wide variety of materials might be used, and that features including but not limited to heating elements could be employed so that the thermal conductivity of the elements may be a secondary consideration. For example and without limitation, it may be desirable for certain applications to use stainless steel in order to provide durability or comply with commercial food preparation regulations, whereas a polycarbonate might be preferable for residential use.

The water reservoir 102 and brew vessel 100 may be stackably mounted during brewing. The bottom of the truncated conical section 200 of the water reservoir 102 presents a circular contact surface which is mated with the brew vessel 100 via the base plate 206. A gasket 208 may be placed between the reservoir and the base plate to inhibit fluid leakage. The base plate 206, which is secured to the water reservoir, rests on top of the brew vessel and functions as a lid in order to help retain heat within the brew vessel. The inflow valve 104 may be used to secure the water reservoir to the base plate. For example, a threaded distal end 210 of the inflow valve may be secured to a diffuser 212 with matching threads, with the base plate located therebetween. The inflow valve may be located inside the reservoir 102 and have a flange 214 which helps to secure the reservoir against the base plate. The outflow valve 106 may be located outside of the brew vessel 100, being secured thereagainst by a retaining nut 216 located within the brew vessel. More particularly, the retaining nut and outflow valve have matching threads. A gasket 218 may be disposed between the outflow valve and the brew vessel to help inhibit fluid leakage. A threaded valve nozzle 220 may be secured to a threaded lower distal end of the outflow valve. A strainer 222 may be provided within the brew vessel to support a removable filter and separate grounds from the outflow valve. The water reservoir and brew vessel may be supported by an upright pole member 108 and base 110 with drip pan 111, or stacked as a freestanding unit, e.g., resting on a carafe, cup, beaker or other receptacle 112. The various elements may be described as being “connected” or “mated” when stacked, regardless of whether they are secured to one another and regardless of whether other elements, e.g., gaskets, are disposed therebetween.

The inflow and outflow control valves 104, 106 may be implemented with any of a wide variety of valve types including but not limited to ball valves, butterfly valves, disc valves, choke valves, diaphragm valves, gate valves, globe valves, knife valves, needle valves, pinch valves, piston valves, plug valves, and poppet valves. In the illustrated example the inflow valve 104 is a type of choke valve which includes a cylindrical body 224 and a regulating pin 226. The regulating pin fits snugly but rotatably against inner walls of the cylindrical body. An opening 228 through the cylindrical body allows fluid to flow from the water reservoir into the cylindrical body when the opening is unblocked. Rotational movement of the retaining pin 226 determines the extent to which the opening 228 is blocked. A handle 113 may allow control of the retaining pin from outside the water reservoir. For example, the regulating pin may be settable such that the opening 228 can be completely blocked, completely unblocked, and partially blocked to various degrees, thereby allowing control of the rate at which fluid flows out of the reservoir via gravitational force. Markings or other indicia 230 may be provided to facilitate simple and repeatable setting at any of various rates of flow. In the illustrated example the outflow valve 106 is a butterfly valve. The valve includes a cylindrical body and a disk which is located within the body and has a diameter of similar dimensions as the inner diameter of the cylindrical body. A handle enables the disk to be rotated within the body such that the inner body can be completely blocked, completely unblocked, and partially blocked to various degrees, thereby allowing control of the rate at which fluid flows out of the brew vessel via gravitational force. Markings or other indicia 232 may be provided to facilitate simple and repeatable setting at any of various rates of flow. It will therefore be appreciated that both the rate of water inflow to the brew vessel and rate of beverage outflow from the brew vessel can be set and dynamically adjusted during brewing in order to implement various brewing styles.

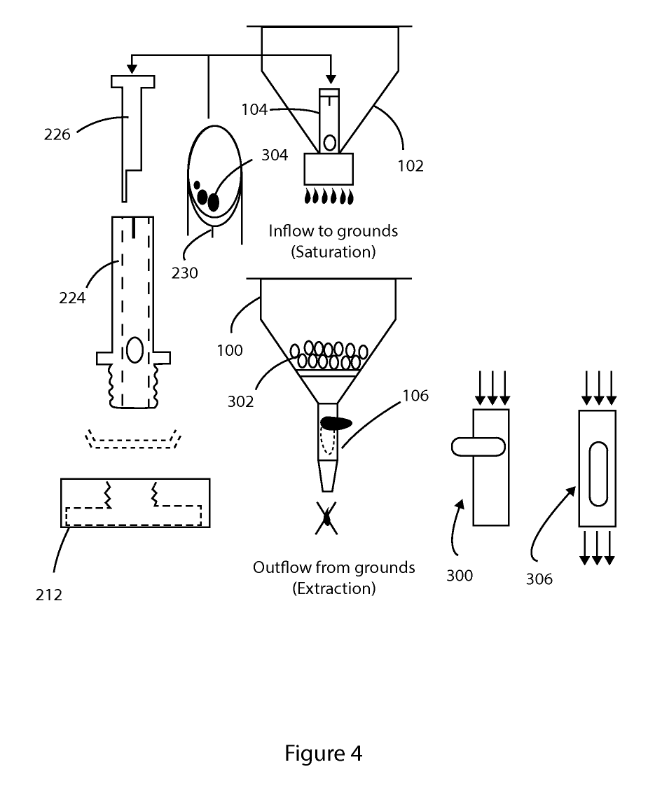

Referring to FIG. 4, in order to replicate the French press style the inflow valve 104 and outflow valve 106 are both initially closed so that fluid cannot flow. See outflow valve at position 300. A receiving vessel such as a carafe, cup, beaker or mug is located beneath the brew vessel. Coarse ground coffee 302 is then placed in the brew vessel 100. The coffee may be placed in a disposable or reusable filter which is positioned within the brew vessel on top of the strainer to facilitate separation and removal of spent grounds. A first set of markings within the brew vessel may provide a visual indication of the volume of grounds to be used. The water reservoir 102 is then stacked on top of the brew vessel 100, e.g., by resting the base plate on top of the brew vessel. Heated water is then inserted into the reservoir. A first set of markings within the reservoir may provide a visual indication of the volume of water to be used. The inflow valve 104 is then reset to full open, thereby allowing the heated water to quickly flow through the diffuser and onto the grounds in the brew vessel. An indicator 304 on the regulating pin 226 may show the setting of the full open position of the pin relative to the indicia 230 on the cylindrical body 224. The diffuser 212 may distribute the water in a circular spray pattern having a diameter approximately equal to the brew vessel or in some other pattern such that the water is distributed across most or all of the grounds. Once all of the heated water has flowed into the brew vessel the extraction is allowed to occur for about 4 minutes. After the 4 minutes have elapsed the outflow valve is reset to full open (see outflow valve position 306) to allow the resulting French press style coffee to pour into the receiving vessel. With a volume of coarse grind coffee in the brew vessel for a 12 ounce cup and the outflow valve set to full open after brewing the outflow rate is about 0.3 ounces per second.

It will be appreciated that the French press style could be reproduced without the water reservoir 102 and inflow valve 104. For example, heated water could be poured from a kettle or other source directly into the brewing vessel 100 because the volumetric ratio of water to grounds for the French press style is determined by the total amount of water and grounds being used rather than inflow relative to outflow. The base plate might still be used to help maintain the temperature of the water. Moreover, tea could be prepared by following the French press procedure but using potentially different contact time.

A variation of the French press style is cold infusion. The technique for producing a cold infusion style coffee is similar to the French press technique described above. However, cold or room temperature water is used rather than hot water. Further, the infusion time tends to be much longer, e.g., up to 24 hours. The ground size may also differ. Cold infusion produces a beverage that is lower in acidity, which may sometimes be preferable. Cold infusion can be used for tea as well as coffee preparation.

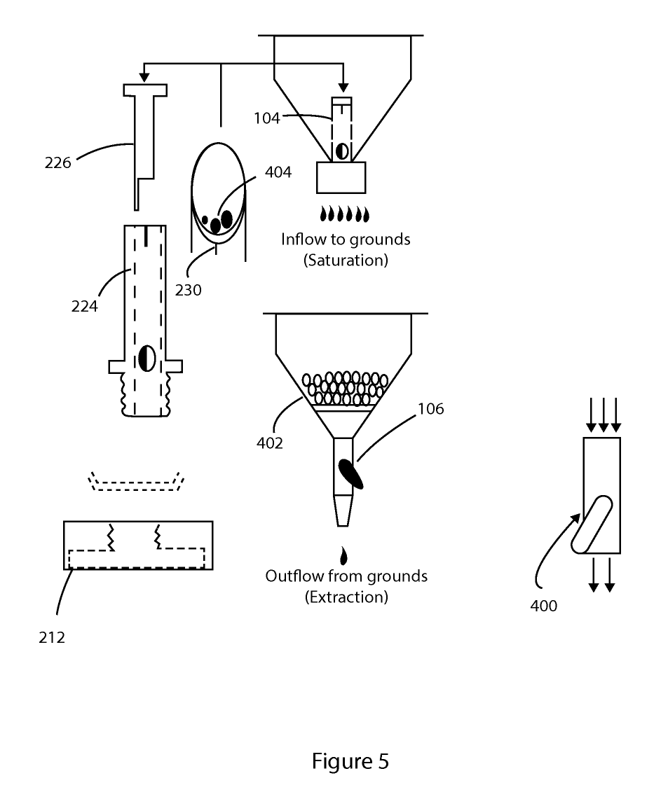

Referring to FIG. 5, in order to replicate the automatic drip (filter drip) method the inflow valve 104 is initially closed so that fluid cannot flow. The outflow valve 106 is set to a partially open setting, e.g., half open. See outflow valve position 400. Markings may be provided to help the user set the outflow valve for the automatic drip style. A receiving vessel such as a carafe, cup, beaker or mug is located beneath the brew vessel. A measured amount of medium ground coffee 402 is then placed in a disposable or reusable filter which is placed in the brew vessel on the strainer. A second set of markings within the brew vessel may provide a visual indication of the volume of grounds to be used. The reservoir is then stacked on top of the brew vessel. Heated water is then inserted into the reservoir. A second set of markings within the reservoir may provide a visual indication of the volume of water to be used. The inflow valve 104 is then reset to a partially open setting, e.g., half open, thereby allowing the heated water to flow through the diffuser and onto the grounds in the brew vessel at a predetermined rate. Markings 404 may be provided to help the user set the inflow valve relative to indicia 230 for the automatic drip style. The diffuser 212 distributes the water in a circular spray pattern such that the water is distributed across most or all of the grounds. The flow rate of the outflow valve 400 in comparison with the flow rate of the inflow valve 104 is set such that proper contact time for the style is attained. In general, the inflow rate is greater than the outflow rate and the water pools in the brew vessel. Further, the relative differences between inflow and outflow rates is such that the average volumetric ratio of water to grounds during contact is less than the corresponding ratio for the French press style but greater than pour-over style. It will be appreciated that without outflow control the water would quickly pass through the medium grind coffee, resulting in under-extraction. While contact time is a design choice, and may be adjusted by the operator using the valves, the medium grind typically calls for a contact time that is less than that of the coarse grind. With a volume of medium grind coffee in the brew vessel for a 12 ounce cup and the inflow and outflow valves set partially open (at a filter drip settings) the inflow rate is about 0.17 ounces per second and the outflow rate is about 0.10 ounces per second. The resulting beverage flows into the receiving vessel and is ready to serve once flow has ceased.

A variation on the automatic drip method described above is to introduce the heated water in multiple pulses. For example, the inflow valve 104 can be dynamically adjusted between full open and full closed at timed intervals during brewing such that pulses of heated water are delivered into the brew vessel.

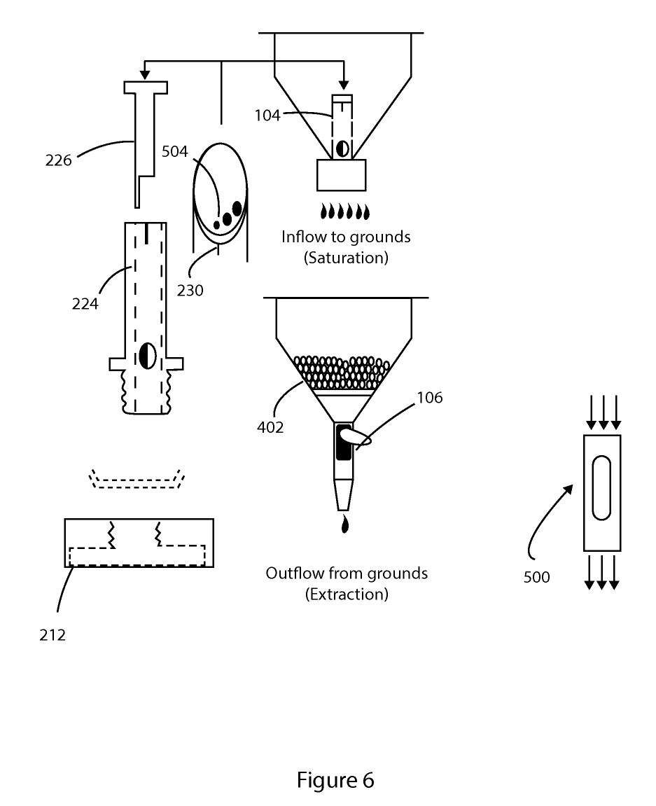

Referring to FIG. 6, in order to replicate the pour-over style the inflow valve 104 is initially closed so that fluid cannot flow. The outflow valve 106 is set to a relatively free-flowing setting, e.g., nearly or completely open. See outflow valve at position 500. Markings may be provided to help the user set the outflow valve for the pour-over style. A receiving vessel such as a carafe, cup, beaker or mug is located beneath the brew vessel. A measured amount of medium-fine ground coffee 502 is then placed in a disposable or reusable filter which is placed in the brew vessel on the strainer. A third set of markings within the brew vessel may provide a visual indication of the volume of grounds to be used. The reservoir is then stacked on top of the brew vessel. Heated water is then inserted into the reservoir. A third set of markings within the reservoir may provide a visual indication of the volume of water to be used. The inflow valve 104 is then reset to a partially open setting, e.g., less than half open, thereby allowing the heated water to flow through the diffuser and onto the grounds in the brew vessel at a predetermined rate. Markings 504 may be provided to help the user set the inflow valve relative to indicia 230 for the pour-over style. The diffuser 212 distributes the water in a circular spray pattern such that the water is distributed across most or all of the grounds. The contact time may be primarily a function of inflow rate. In general, the inflow rate is set such that the water does not pool in the brew vessel but rather maintains the wetted grounds in a mud-like consistency. In other words, the average volumetric ratio of water to grounds during contact is less than the corresponding ratio for the automatic drip style. It will be appreciated that without inflow control the water would pool in the brew vessel, possibly resulting in over-extraction. While contact time is a design choice, and may be adjusted by the operator using the valves, the medium-fine grind typically calls for a contact time that is less than that of the medium grind. With a volume of fine grind coffee in the brew vessel for a 12 ounce cup, the inflow valve set partially open (at a pour-over setting) and the outflow valve fully open the inflow rate is about 0.24 ounces per second and the outflow rate is about 0.13 ounces per second. The resulting beverage flows into the receiving vessel and is ready to serve once flow has ceased.

A variation on the pour-over method described above is to introduce the heated water in multiple pulses. For example, the inflow valve can be reset between partially or fully open and fully closed at timed intervals such that pulses of heated water are delivered into the brew vessel.

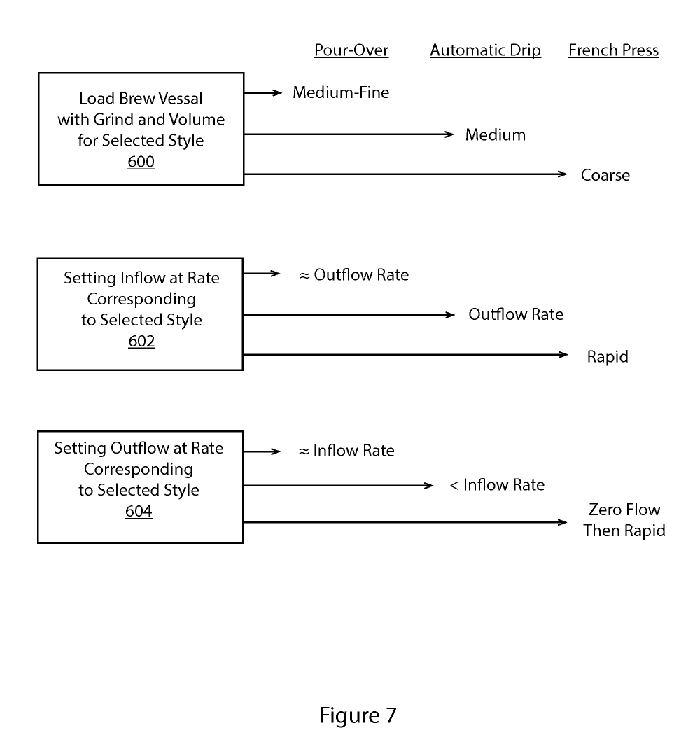

FIG. 7 is a flow diagram which shows a method of changing brew style using the device of FIG. 1. The method includes three basic steps which may be varied or dynamically adjusted in implementation in order to achieve different results with the device. Step 600 is to load the brew vessel with the proper grind and volume for the selected style. For example, the grind might be medium-fine for the pour-over style, medium for the automatic drip style, and coarse for the French press style. Step 602 is setting the inflow rate to correspond to the selected style. For example, the inflow rate might be approximately equal to the outflow rate for the pour-over style, greater than the outflow rate for the automatic drip style, and rapid for the French press style. Step 604 is setting the outflow rate to correspond to the selected style. For example, the outflow rate might be approximately equal to the inflow rate for the pour-over style, less than the inflow rate for the automatic drip style, and zero flow followed by rapid after brewing for the French press style. It will be understood that the device is not limited to the styles described above. Any of a wide variety of variables could be adjusted depending on user-preference to implement a variety of styles and variations thereof. For example, and without limitation, the inflow and outflow rates could be dynamically adjusted during the brewing process, e.g., pulses of inflow and temporary pooling in the brew vessel caused by increasing outflow rate over time.

A number of implementations have been described. Nevertheless, it will be understood that additional modifications may be made without departing from the scope of the inventive concepts described herein, and, accordingly, other embodiments are within the scope of the following claims.

What is claimed is:

1. Apparatus comprising:
a brewing vessel; and
an adjustable outflow valve mated to the brewing vessel.

2. The apparatus of claim 1 in which the outflow valve controls contact time between water and grounds in the brewing vessel.

3. The apparatus of claim 1 further comprising a water reservoir and an adjustable inflow valve connected to the brewing vessel, and in which the inflow valve controls a rate at which water flows into the brewing vessel.

4. The apparatus of claim 3 wherein the inflow valve and outflow valve are set to achieve a predetermined contact time between water and grounds in the brewing vessel.

5. The apparatus of claim 4 wherein the inflow valve and outflow valve are set to achieve a predetermined average volumetric ratio of water to grounds in the brewing vessel during contact.

6. The apparatus of claim 3 further comprising a diffuser connected to the inflow valve to distribute water flowing into the brewing vessel in a predetermined pattern.

7. The apparatus of claim 6 further comprising an inflow valve setting indicator and an outflow valve setting indicator for an automatic drip style.

8. The apparatus of claim 7 further comprising an inflow valve setting indicator for a pour-over style.

9. A method comprising:
placing a predetermined amount of grounds in a brewing vessel;
setting an adjustable outflow valve connected to the brewing vessel to a setting selected plurality of settings corresponding to different brew styles; and
causing water to flow into the brewing vessel.

10. The method of claim 9 including changing the setting of the outflow valve to control contact time between the water and the grounds in the brewing vessel.

12. The method of claim 9 further comprising setting an adjustable inflow valve connected to the brewing vessel to a setting selected plurality of settings corresponding to the brew styles, and in which the inflow valve controls a rate at which the water flows into the brewing vessel.

13. The method of claim 12 including changing the settings of the inflow valve and outflow valve to achieve a different brew style corresponding to a different contact time between water and grounds in the brewing vessel.

14. The method of claim 12 including changing the settings of the inflow valve and outflow valve to achieve a different brew style corresponding to a different average volumetric ratio of water to grounds in the brewing vessel during contact.
